(19) United States
(12) Patent Application Publication
(10) Pub. No.: US 2013/0201673 A1
(43) Pub. Date: Aug. 8, 2013

(54) The Device has LED Track means with removable LED-units which clip-on anywhere along the length or add-on from ends

(71) Applicant: Tseng-Lu CHIEN, Walnut, CA (US)

(72) Inventor: Tseng-Lu CHIEN, Walnut, CA (US)

(21) Appl. No.: 13/367,687

(22) Filed: Feb. 7, 2012

(51) Int. Cl. F21S 4/00; F21V 17/16; F21V 21/08; F21V 17/12; F21V 21/088; F21V 21/096

(52) U.S. Cl. 362/217.13

(57) ABSTRACT

The Device has LED Track means with removable LED-units which clip-on anywhere along the length or add-on from ends for LED light device including LED florescent tube, LED light bar, LED Bulb, LED PL lamp, LED Lamp as light source sealed inside a protective means to form a finish light source look similar with non-LED light source with removable LED-unit(s) or LED-assembly(ies) with build-in LED-elements to allow people to adjust the position of said LED-unit(s) or LED-assembly(ies) to the desire location, position, orientation in x-y-z axis geometric dimension get the best illumination by less of the LED-element(s) number. The current invention save non-required illumination area(s)'s LED-element(s), power consumptions to allow people get lower cost of the current invention's LED light source to save money for unit cost and save money from electric bill and save earth.

### BACKGROUND

This is continuously filing for Ser. No. 13/296,508 “The device has build-in Digital Data means and powered by unlimited power source of the LED Bulb”. This is continuously filing for Ser. No. 13/295,301 “The device has build-in Digital Data means and powered by unlimited power source of the Light Device”. This is continuously filing for Ser. No. 13/296,469 “The device has build-in Digital Data means and powered by unlimited power source of the Lamp Holder”.

All these are Continuously filing for Ser. No. 13/296,508, Ser. No. 13/295,301, Ser. No. 13/296,469 are continuously filing for Ser. No. 13/162,824 Light device with display means has track-means and removable LED-unit(s) which are the continuously filing for Ser. No. 12/938,628 LED light fixture has outlet(s) and removable LED unit(s) and for Ser. No. 12/887,700 Light fixture with self-power removable LED unit(s). Those are continuously filing for Ser. No. 12/149,963 (Now U.S. Pat. No. 7,722,230), Ser. No. 12/073,095 (Now U.S. Pat. No. 7,726,869), Ser. No. 12/073,889 (Co-Pending Filing), Ser. No. 12/007,076 (Now U.S. Pat. No. 7,726,841), Ser. No. 12/003,691 (Now U.S. Pat. No. 7,726,839), Ser. No. 12/894,865 (Co-Pending Filing).

The current invention design for LED bulb or LED Florescent tube or other LED light source which The Device has LED Track means with removable LED-units which clip-on anywhere along the length or add-on from ends.

From market place all the said LED Bulb or LED Florescent tube of other LED light source which normally has special design such as Philips or Osram or Feith with their complicated construction in order to get wide view angle of light and high brightness. But each of them has very complicated construction and costly for their design. The current invention incorporated unique removable LED-units along the track means can easily to get the

(1) Add or Reduce Removable LED-units anywhere along the length or from ends
(2) Only need to make several different numbers of surface track-means can make variety different brightness, size, diameter, length, viewing angle, shape to get full range of existing incandescent bulb or really florescent tube or other light source's looking to let consumer replace without any mistake
(3) Offer sufficient working illumination as head-width and get the LED illumination as people's shoulder width to save non-working area(s) illumination which means save a lot of power consumption of non-working area(s) LED light cost and energy saving
(4) Come out the most economical LED light source to let consumer willing to replace the Incandescent or Really Florescent tube to super power saving LED light source to save power consumption, save money, save energy and save earth.

The most important the current invention can make any requirement for brightness, illumination areas, color of light, size of illumination area(s) and can be adjustable the above details by consumer itself in seconds.

It is appreciated the current invention has all above discussed co-pending or issued patent's drawing, details description and content are still been the parent filing of the current invention and all such drawing, detail description, contents should be still fall within the scope of the current invention and not limited to the current drawing, details description, content.

### DRAWING

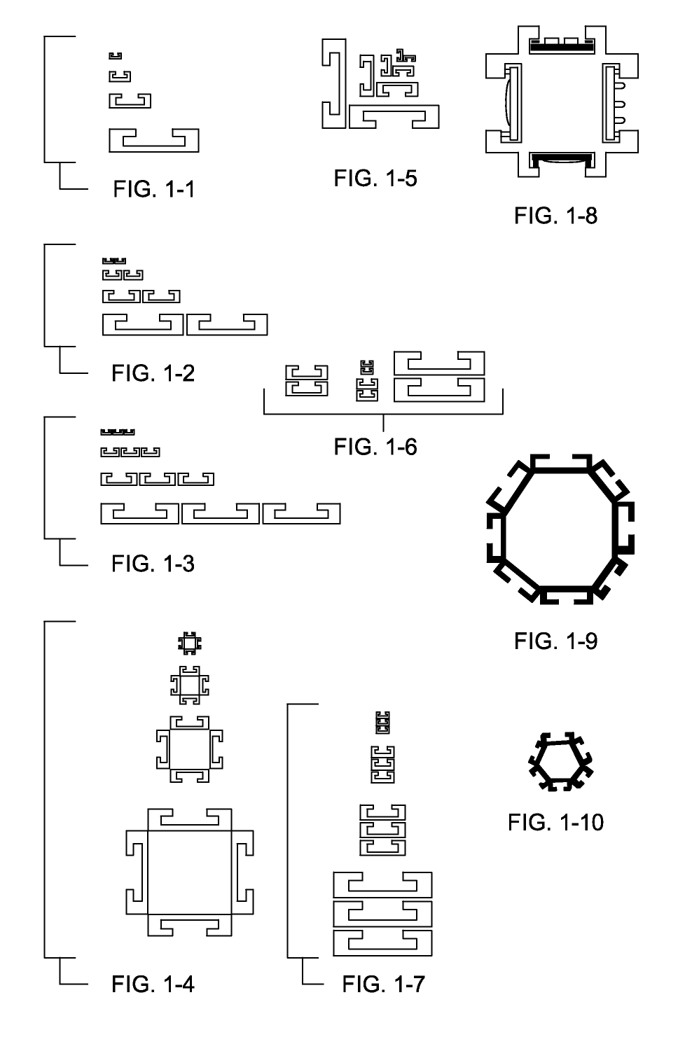

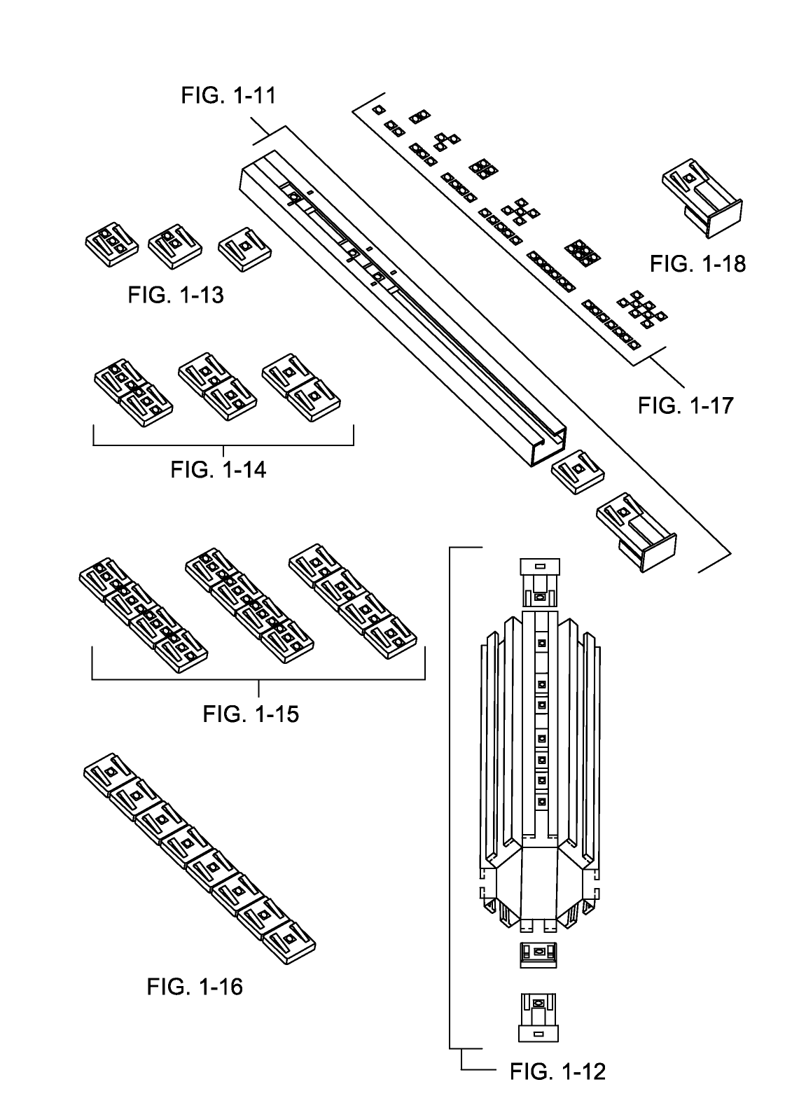

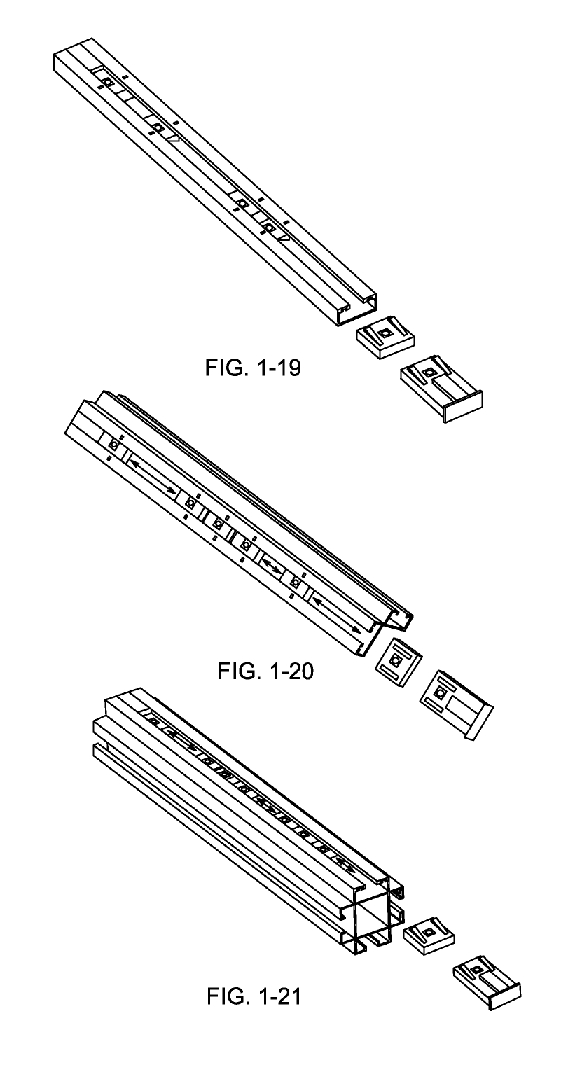

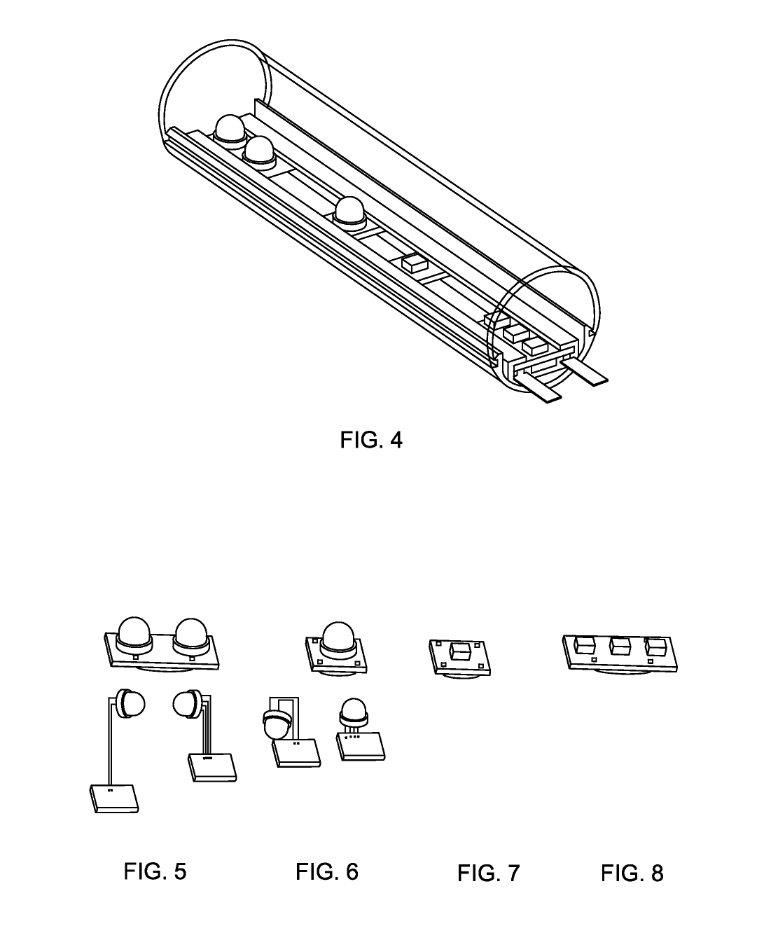

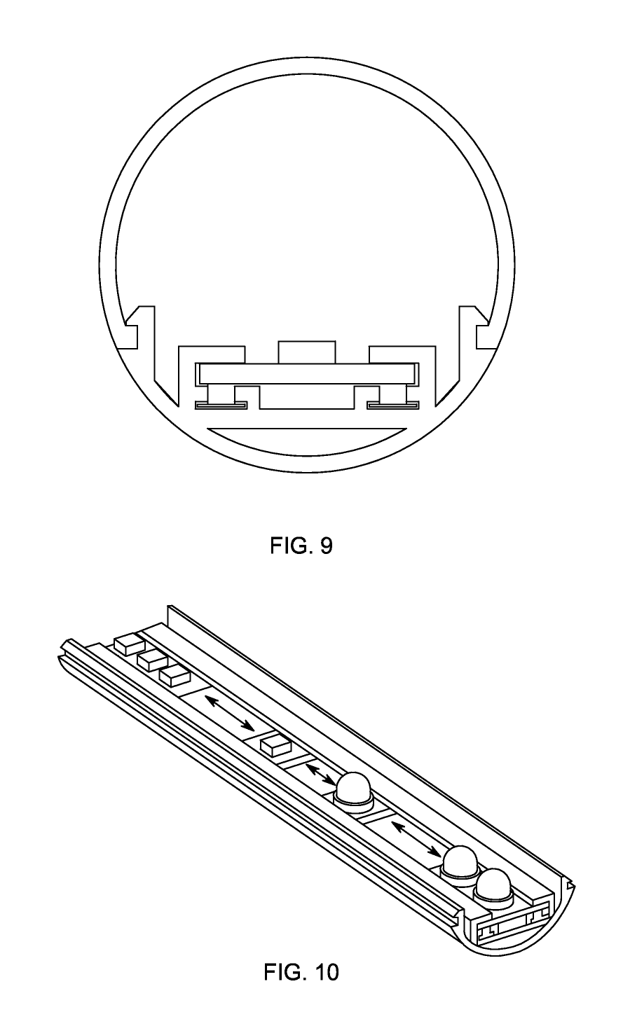

1. FIG. 1-1 to FIG. 1-10 disclosure the different arrangement for track means for One track means to 8 track means for desire arrangement. More than one track means can has desire geometric arrangement in x-y-z axis to make the different light effects while has certain number of LED-unit(s) or LED-assembly (ies) with build-in LED elements.

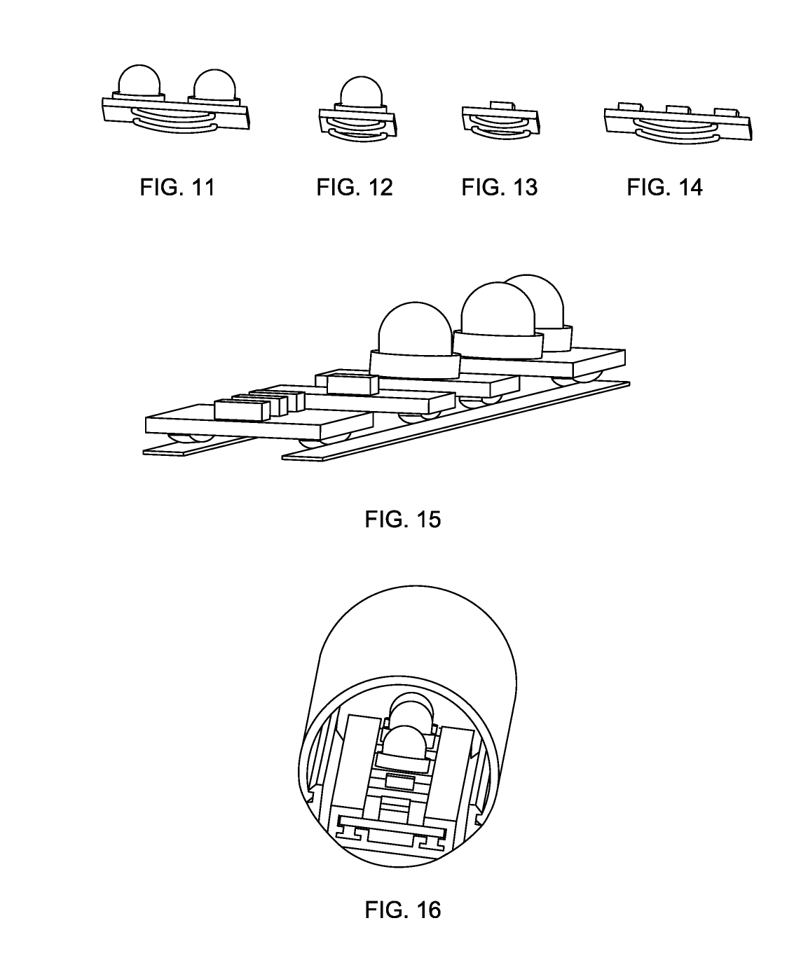

2. FIGS. 1-11 to 1-18 disclosure the different size and arrangement for the LED-unit(s) or LED-assembly(ies) which has housing means to sealed each of LED-unit(s) or LED-assembly(ies). Also, disclosure the LED-element(s) arrange on each of the said LED-unit(s) or LED-assembly(ies).

3. From FIGS. 1-19 to 1-21 disclosure the LED-unit(s) or LED-assembly(ies) has resilient/elastic conductive means and add, replace, reduce, assembly, dis-assembly into the said one track means or more than one track means which has desire geometric combination in x-y-z axis to make the desire position, relation, orientation of each track means so the build-in LED-element(s) will make certain light function(s), performance(s), light show(s) as pre-determined program.

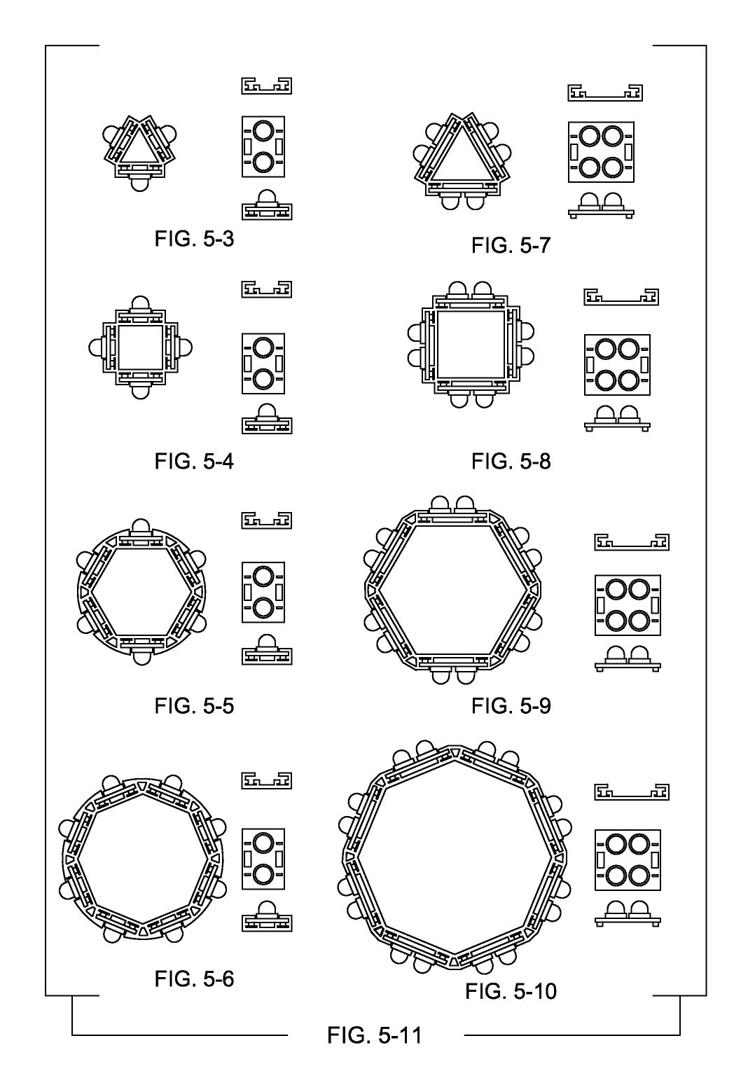

4. From FIG. 29 to FIG. 33 disclosure the current invention for the Light source has LED-unit(s) or LED-assembly(ies) with movable conductive means to clip, add, insert, replace, remove, assembly, dis-assembly the said LED-unit(s) or LED-assembly(ies) at anywhere along the track means for current invention. The current invention has protective means to arrange all said LED-unit(s) or LED-assembly(ies) within so can become a finish light source.

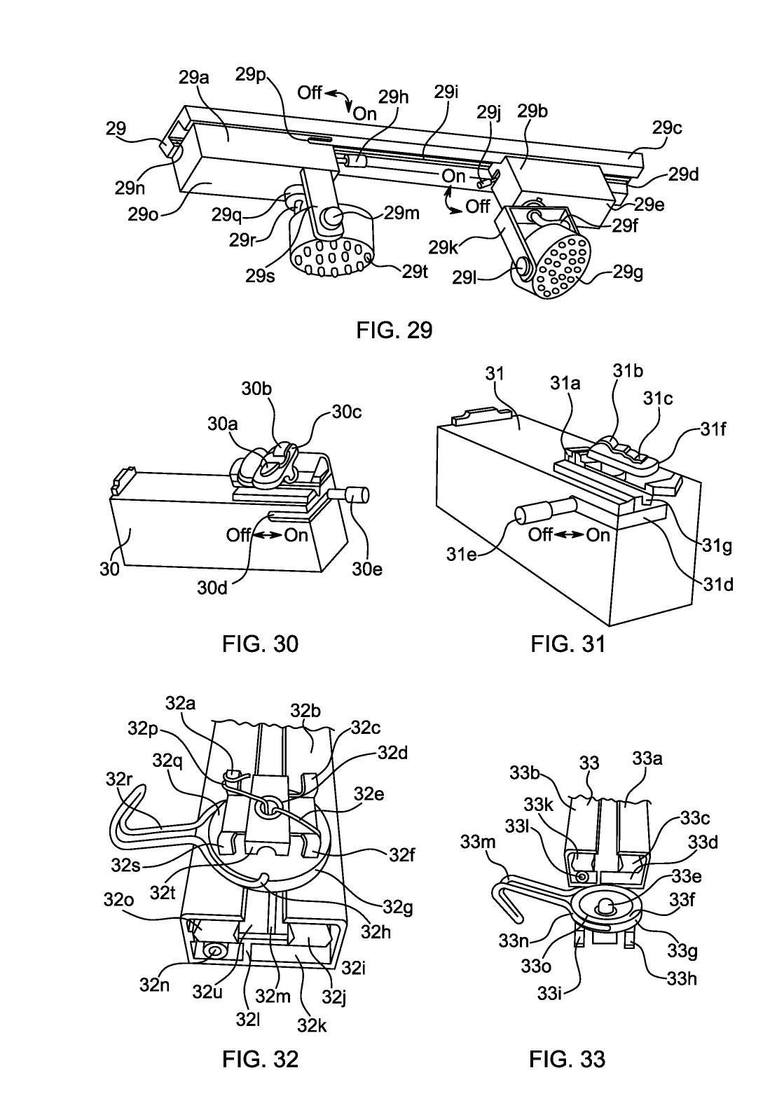

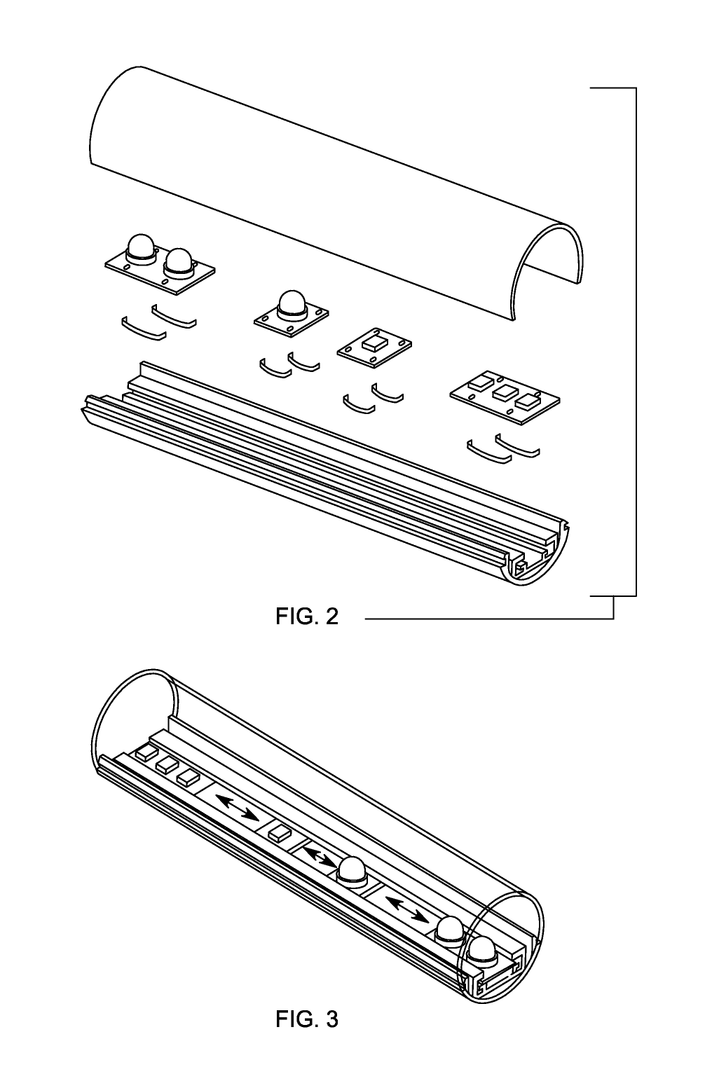

5. From FIG. 2 to FIG. 16 disclosure the construction of the current invention for protective means, and LED-unit(s) or LED-assembly(ies), and resilient/elastic conductive means or moveable conductive means, and track-means relations.

6. From FIG. 5-11 disclosure more than one of track means geometric arrangement in x-y-z axis to get minimum and maximum size to make desired light performance which including 3,4,6,8 track means each track means has different LED-unit(s) or LED-assembly(ies) with build-in different size, number of LEDs LED-elements so can make the different geometric size/shape/tube/bar for light device.

### DETAILS DESCRIPTION

The current invention apply the co-inventor's prior art or co-pending filing cases of the removable LED-unit(s) or LED-assembly(ies) with Build-in LED-elements has resilient/elastic or movable conductive means to add, reduce, replace, insert, assembly, dis-assembly the said LED-unit(s) or LED-assembly(ies) at anywhere along the track means to get the most power saving, less cost, adjustable illumination area(s), practically un-expensive LED light source which has similar outlook with existing non-LED light sources including Florescent tube, Incandescent bulb, PL lamp,

U-lamp or other light source which is not LED related light available from market place.

In order to make simple and clear description for all drawing, so all drawing has brief notes for quickly review has its features.

From FIG. 1-1 to FIG. 1-10 disclosure the different arrangement for track means for One track means to 8 track means for desire arrangement. More than one track means can has desire geometric arrangement in x-y-z axis to make the different light effects while has certain number of LED-unit(s) or LED-assembly (ies) with build-in LED elements.

From FIGS. 1-11 to 1-18 disclosure the different size and arrangement for the LED-unit(s) or LED-assembly(ies) which has housing means to sealed each of LED-unit(s) or LED-assembly(ies). Also, disclosure the LED-element(s) arrange on each of the said LED-unit(s) or LED-assembly(ies).

From FIGS. 1-19 to 1-21 disclosure the LED-unit(s) or LED-assembly(ies) has resilient/elastic conductive means and add, replace, reduce, assembly, dis-assembly into the said one track means or more than one track means which has desire geometric combination in x-y-z axis to make the desire position, relation, orientation of each track means so the build-in LED-element(s) will make certain light function(s), performance(s), light show(s) as pre-determined program.

From FIG. 29 to FIG. 33 disclosure the current invention for the Light source has LED-unit(s) or LED-assembly(ies) with movable conductive means to clip, add, insert, replace, remove, assembly, dis-assembly the said LED-unit(s) or LED-assembly(ies) at anywhere along the track means for current invention. The current invention has protective means to arrange all said LED-unit(s) or LED-assembly(ies) within so can become a finish light source.

From FIG. 2 to FIG. 16 disclosure the construction of the current invention for protective means, and LED-unit(s) or LED-assembly(ies), and resilient/elastic conductive means or moveable conductive means, and track-means relations.

From FIG. 5-11 disclosure more than one of track means geometric arrangement in x-y-z axis to get minimum and maximum size to make desired light performance which including 3,4,6,8 track means each track means has different LED-unit(s) or LED-assembly(ies) with build-in different size, number of LEDs LED-elements so can make the different geometric size/shape/tube/bar for light.

From these drawing can get the following features of the current invention as below point by points including:

1. The Device has LED Track means with removable LED-units which clip-on anywhere along the length or add-on from ends consist of;

At least one of the Removable LED-unit or LED-assembly has desire number of LED element(s) arrangement to get certain brightness, color, directions, viewing angle(s), illumination area(s), Size of illumination area(s) to offer people to get desired illumination.

At least one of the removable LED-units which without the circuit & parts or LED-assembly which has the circuit & parts can add, replace, reduce from anywhere along the track-means or from the ends.

At least one of the said LED-unit(s) or LED-Assembly(ies) has elastic or movable conductive means to allow the said clip or add on at any position along the said track means and build the electric connection to make the said LED element(s) of the said LED-unit(s) or LED-assembly(ies) to turn-on and turn-off under pre-determined function(s), performance, duration.

The Said LED-unit(s) without the circuit so it will get the LED element(s) trigger electric signal from the track means as input-signal for the LED-unit's LED element(s). the said track-means has at least one positive and one negative electric bus-means to supply the said bus-means' out-put electric signal to said LED elements as input-signal to make said LED-element(s) to get the desire performance, function, light show, duration.

The said LED-assembly(ies) has its own circuit and parts & accessories so LED-assembly(ies)'s LED-element(s) will get the electric signal from its owned circuit and parts & accessories. The LED-assembly(ies)'s track-means has at least one positive and one negative bus-means to supply the LED-assembly(ies)'s circuit for input electric signal and change the input electric signal by its owned circuit to the output-signal to LED-assembly(ies)'s LED elements to make the predetermined function, performance, light show, duration.

The above said LED-unit or LED-assembly can add, reduce, move, assembly, dis-assembly at anywhere along the said track means by the clip-on, twist-on, bend-on, magnetic-on, screw-on, insert-on or other attachment means to install the said LED-unit or LED-assembly on the said track-means to build the electric delivery.

The said LED-unit or LED-assembly or Device has its geometric design, shape, size, cover, housing, isolate body, cover, safety screw, hold-area(s), to allow people can direct or indirectly touch to make the LED-unit(s) or LED-assembly (ies) to move, change position or add, reduce, remove, assembly, dis-assembly, at anywhere along the track means.

The improvement including;

The said Device has its protective-means which may group combination from the said housing, cover, lid, shade, plastic piece, transparent piece, translucent piece, areas, windows, opening(s), cut-out areas to allow people to change position, add, reduce, replace, assembly or dis-assembly, clip, fasten, twist, push, fix the said LED-unit(s) or LED-assembly(ies) from these protective means.

2. The Device has LED Track means with removable LED-units which clip-on anywhere along the length or add-on from ends, the said track-means can made by plastic or metal material.

3. The Device has LED Track means with removable LED-units which clip-on anywhere along the length or add-on from ends, the said device in a form of LED florescent tube, LED Bulb, LED PL lamp or other shape of the LED device(s) has the shape, design, outlook similar to conventional traditional non-LED florescent tube(s), incandescent bulb(s), PL lamp, Halogen lamp, gas fill lamp.

4. The Device has LED Track means with removable LED-units which clip-on anywhere along the length or add-on from ends, the said movable conductive means can be change conductive means from position A to position B or more position to make the conductive means to build the electric delivery or disconnect the electric delivery.

5. The Device has LED Track means with removable LED-units which clip-on anywhere along the length or add-on from ends, the said elastic conductive means can change the shape while force applied to it but still make the electric delivery by its elastic properties at any time within the track means.

6. The Device has LED Track means with removable LED-units which clip-on anywhere along the length or add-on from ends, the said movable or elastic conductive means made by conductive material in the desired forms including desire combination from piece, plate, spring, strips, wires, conductive printing material which can deliver the electric signal from one place to other place.

7. The Device has LED Track means with removable LED-units which clip-on anywhere along the length or add-on from ends, the said LED-unit(s) or LED-assembly(ies) has LED-elements for people head-width to get the illumination cover people shoulder-width for preferred arrangement to save power and LED-element(s) number and save money.

8. The Device has LED Track means with removable LED-units which clip-on anywhere along the length or add-on from ends, the said track means for desire light function(s), performance(s), light show can has more than one of positive or more than one negative bus-means to connect with multiple electric terminals for light source.

9. The Device has LED Track means with removable LED-units which clip-on anywhere along the length or add-on from ends, the said track means has more than one of the track means for the device and each track means has desire geometric arrangement in x-y-z axis(es) to each of the said track means.

10. The Device has LED Track means with removable LED-units which clip-on anywhere along the length or add-on from ends, The said bus-means is made by conductive material.

11. The Device has LED Track means with removable LED-units which clip-on anywhere along the length or add-on from ends, the said protective means has size, dimension, area(s) to meet market requirement.

12. The Device has LED Track means with removable LED-units which clip-on anywhere along the length or add-on from ends, the said LED-element(s) can be any specification from market available type, size, number of colors, number of electric terminals, brightness, diameter, life, functions.

It is appreciated all the above discussed or refer to or described of the co-inventor's Prior arts, co-pending filing, notes on drawing, alternative parts & accessories, equivalent functional parts & accessories are still fall within the scope of the current invention. It is appreciated the current invention has all above discussed co-pending or issued patent's drawing, details description and content are still been the parent filing of the current invention and all such drawing, detail description, contents should be still fall within the scope of the current invention and not limited to the current drawing, details description, content.

1. The Device has LED Track means with removable LED-units which clip-on anywhere along the length or add-on from ends consist of;
At least one of the Removable LED-unit or LED-assembly has build-in desire number of LED-element(s) arrangement to get certain brightness, color, directions, viewing angle(s), illumination area(s), Size of illumination area(s) to offer people to get desired illumination.
At least one of the removable LED-units which without the circuit & parts or LED-assembly which has the circuit & parts can add, replace, reduce from anywhere along the track-means or from the ends.
At least one of the said LED-unit(s) or LED-Assembly(ies) has elastic or resilient or movable conductive means to allow the said clip, add, install, arrange at any position along the said track means and build the electric connection to make the said build-in LED-element(s) of the said LED-unit(s) or LED-assembly(ies) to turn-on and turn-off under pre-determined function(s), performance, duration.
The Said LED-unit(s) without the circuit so it will get the build-in LED-element(s) trigger electric signal from the track means as input-signal for the LED-unit's build-in LED-element(s). the said track-means has at least one positive and one negative electric bus-means to supply the said bus-means' out-put electric signal to said build-in LED-elements as input-signal to make said build-in LED-element(s) to get the desire performance, function, light show, duration.
The said LED-assembly(ies) has its own circuit and parts & accessories so LED-assembly(ies)'s build-in LED-element(s) will get the electric signal from its owned circuit and parts & accessories. The LED-assembly(ies)'s track-means has at least one positive and one negative bus-means to supply the LED-assembly(ies)'s circuit for input electric signal and change the input electric signal by its owned circuit to the output-signal to LED-assembly(ies)'s build-in LED-elements to make the predetermined function, performance, light show, duration.
The above said LED-unit or LED-assembly can add, reduce, move, assembly, dis-assembly, install, arrange at anywhere along the said track means by the clip-on, twist-on, bend-on, magnetic-on, screw-on, insert-on or other attachment means to install the said LED-unit or LED-assembly on the said track-means to build the electric delivery.
The said LED-unit or LED-assembly or Device has its geometric design, shape, size, cover, housing, isolate body, cover, safety screw, hold-area(s), to allow people can direct or indirectly touch to make the LED-unit(s) or LED-assembly (ies) to move, change position or add, reduce, remove, assembly, dis-assembly, at anywhere along the track means.
The improvement including;
The said Device has its protective-means which may group combination from the said housing, cover, lid, shade, plastic piece, transparent piece, translucent piece, areas, windows, opening(s), cut-out areas to allow people to change position, add, reduce, replace, install, arrange, assembly or dis-assembly, clip, fasten, twist, push, fix the said LED-unit(s) or LED-assembly(ies) from these protective means.

2. The Device has LED Track means with removable LED-units which clip-on anywhere along the length or add-on from ends as clam 1, the said track-means can made by plastic or metal material.

3. The Device has LED Track means with removable LED-units which clip-on anywhere along the length or add-on from ends as claim 1, the said device in a form of LED florescent tube, LED Bulb, LED PL lamp or other shape of the LED device(s) has the shape, design, outlook similar to conventional traditional non-LED florescent tube(s), incandescent bulb(s), PL lamp, Halogen lamp, gas fill lamp.

4. The Device has LED Track means with removable LED-units which clip-on anywhere along the length or add-on from ends as claim 1, the said movable conductive means can be change conductive means from position A to position B or more position to make the conductive means to build the electric delivery or disconnect the electric delivery.

5. The Device has LED Track means with removable LED-units which clip-on anywhere along the length or add-on from ends as claim 1, the said elastic, resilient conductive means can change the shape while force applied to it but still make the electric delivery by its elastic or resilient properties at any time within the track means.

6. The Device has LED Track means with removable LED-units which clip-on anywhere along the length or add-on from ends as claim 1, the said movable or resilient, elastic conductive means made by conductive material in the desired forms including desire combination from piece, plate, spring, strips, wires, coils, rolls, conductive printing material which can deliver the electric signal from one place to other place.

7. The Device has LED Track means with removable LED-units which clip-on anywhere along the length or add-on from ends as claim 1, the said LED-unit(s) or LED-assembly(ies) has build-in LED-elements for people head-width to get the illumination cover people shoulder-width for preferred arrangement to save power and build-in LED-element(s) number and save money.

8. The Device has LED Track means with removable LED-units which clip-on anywhere along the length or add-on from ends as claim 1, the said track means for desire light function(s), performance(s), light show can has more than one of positive or more than one negative bus-means to connect with multiple electric terminals of the said build-in LED-elements construction.

9. The Device has LED Track means with removable LED-units which clip-on anywhere along the length or add-on from ends as claim 1, the said track means has more than one of the track means for the device and each track means has desire geometric arrangement in x-y-z axis(es) relation to each other or others of the said track means.

10. The Device has LED Track means with removable LED-units which clip-on anywhere along the length or add-on from ends as claim 1, The said bus-means is made by conductive material.

11. The Device has LED Track means with removable LED-units which clip-on anywhere along the length or add-on from ends as claim 1, the said protective means has size, dimension, shape, design, construction, area(s) to meet market requirement.

12. The Device has LED Track means with removable LED-units which clip-on anywhere along the length or add-on from ends as claim 1, the said build-in LED-element(s) can be any specification from market available type, size, shape, dot matrix arrangement of LEDs, number of colors, number of electric terminals, number of surface to install LEDs, brightness, diameter, life, functions.
